(19) United States
(12) Patent Application Publication
(10) Pub. No.: US 2009/0068923 A1
(43) Pub. Date: Mar. 12, 2009

(54) Color toy having clear color boundary

(76) Inventor: Hsin-Huang CHENG, Mingjian Shang (TW)

Correspondence Address: SINORICA, LLC, 528 FALLSGROVE DRIVE, ROCKVILLE, MD, 20850, US

(21) Appl. No.: 12/120,830

(22) Filed: May 15, 2008

(30) Foreign Application Priority Data
Sep. 6, 2007 (TW) 96214955

(51) Int. Cl. A63H 3/36; B29C 39/12

(52) U.S. Cl. 446/268; 264/245

(57) ABSTRACT

A color toy includes a hollow main body. The main body is made from a plurality of color portions having different colors molded together. Between each of the two neighboring color portions is a clear boundary that the color toy of the present invention may have two or more colors and clear boundary therebetween.

### BACKGROUND OF THE INVENTION

1. Field of the Invention

The present invention relates to a hollow color toy, and more particularly to a color toy having clear color boundary.

2. Description of the Related Art

Typically, hollow plastic toys are made by injection molding that such toys are single color. To make multi-color toys, the toys will be painted after the toys are molded.

These painted color toys have fancy looks to attract children, but the paint may be off when children play the toys and crash them on some hard or sharp object. Beside that, some children may put the toy in mouth that the paint may harm children's health so that painting is not a good treatment for a color toy.

### SUMMARY OF THE INVENTION

The primary objective of the present invention is to provide a color toy, which pours plastics with different colors into the cavity of die to mold the toy having portions with various colors and there are clear boundaries between these portions. It would overcome the problems of the conventional painted toys.

To achieve the objective of the present invention, a color toy includes a hollow main body. The main body is made from a plurality of color portions having different colors molded together. Between each of the two neighboring color portions is a clear boundary that the color toy of the present invention may have two or more colors and clear boundary therebetween.

### BRIEF DESCRIPTION OF THE DRAWINGS

FIG. 1 is a perspective view of a preferred embodiment of the present invention.

### DETAILED DESCRIPTION OF THE INVENTION

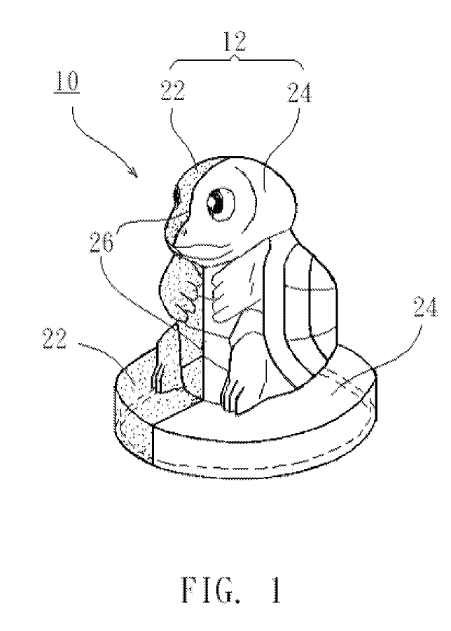

Referring to FIG. 1, a color toy 10 of the present invention has a hollow main body, which is constructed of two shell-like color portions 22, 24. The color portions 22, 24 have different colors and between them is a boundary 26.

A method of making the color toy 10 of the present invention includes pouring a first plastic with a first color into a cavity of a die, which molds the toy, to form the color portion 22. The first plastic is only poured in a half of the cavity. And then, pouring a second plastic with a second color in the die to fill the cavity that forms the color portion 24. After opening the die, a color toy 10 having the color portions 22, 24 is molded. The color portions 22, 24 have different colors and a clear boundary 26 therebetween.

The color toy 10 of the present invention has no painting treatment involved that no drawback of the conventional color toys, peelable paint and children eat the poison paint, will be shown in the present invention.

It has to be mentioned that the color toy of the present invention may have three or more color portions with two or more colors.

In conclusion, the color toy of the present invention provides two or more color portions, which are made by pouring different color plastic in the die. The color toy of the present invention has at least a clear boundary between the color portions. The color toy of the present invention overcomes the problems of the conventional painted color toys, including paint peeling off and children eat the poison paint.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A color toy, comprising a hollow main body, which is made from a plurality of color portions having different colors molded together, wherein a clear boundary is formed between each of the two neighboring color portions.

2. The color toy as claimed in claim 1, wherein the color portions are shell-like members.

3. The color toy as claimed in claim 2, wherein the color portions are made by pouring plastics having different colors in a cavity of a die in different time of molding the main body.

4. A method of making the color toy as defined in claim 1, comprising the steps of pouring a first plastic with a first color in a cavity of a die, wherein the first plastic is not filled the cavity, and then pouring a second plastic with a second color in the die to fill the cavity, and then proceeding a molding process to form the color toy having two color portions with different colors.
